(19) United States
(12) Patent Application Publication
(10) Pub. No.: US 2026/0063889 A1
(43) Pub. Date: Mar. 5, 2026

(54) ENDOSCOPE, EMBED-MOLDED JOINT CONNECTOR AND MANUFACTURING METHOD THEREOF

(71) Applicant: Medimaging Integrated Solution, Inc., Hsinchu (TW)

(72) Inventors: Chu-Ming Cheng, Hsinchu (TW); Yu-Tsung Lee, Hsinchu (TW); CHIA-JUNG LEE, Hsinchu (TW); YUEH-YING FAN, Hsinchu (TW)

(21) Appl. No.: 19/259,658

(22) Filed: Jul. 3, 2025

(30) Foreign Application Priority Data
Aug. 29, 2024 (TW) 113132721

(51) Int. Cl. G02B 23/24; H04N 23/50

(52) U.S. Cl. CPC G02B 23/2484; H04N 23/555

(57) ABSTRACT

The present invention provides an endoscope, an embed-molded joint connector and a manufacturing method thereof. The embed-molded joint connector includes a plurality of joint units and a flexible wire. The joint units are hollow and arranged coaxially. A distance exists between two adjacent joint units to form a gap. The flexible wire is embedded inside the joint units and passes through them. A plurality of portions of the flexible wire is exposed in the gaps, forming bending fulcrums between the joint units. As a result, the present invention effectively simplifies the assembly process, reduces the manufacturing cost, and features radial torsional durability and axial bending functionality.

### BACKGROUND OF THE INVENTION

### 1. Field of the Invention

The present invention relates to an endoscope, an embed-molded joint connector, and a manufacturing method, particularly to an endoscope having radial torsion durability and axial bending function, an embed-molded joint connector able to realize the abovementioned endoscope, and a manufacturing method thereof.

### 2. Description of the Prior Art

The snake-bone structure is the mainstream joints used in endoscopes at present. The terminal of an endoscope is multidirectionally bent and turned to perform complicated and precision observation/operation. The scale processed by modern medicine is growing smaller and smaller. However, the conventional endoscope joint has numerous critical components. Thus, it is hard to operate an endoscope smooth in a limited space. The conventional snake-bone structure is formed by many small joints and the connection members thereof. The conventional snake-bone structure is normally designed to have several joint segments, and the joint segments are coupled to each other by hinges or ball joints. Hinges and ball joints are likely to be damaged or worn out while the endoscope is frequently bent. In the case that the endoscope neither has a sufficient bending angle range nor has a sufficient bending durability, the snake-bone structure may suffer structural disconnection if the operator cannot manipulate the endoscope smooth. Such a situation may cause discomfort or even an irreversible harm during inspection.

The snake-bone structure has numerous components, and these components are delicate and complicated. Once the snake-bone structure is damaged or malfunctions, repair or replacement of components is difficult, laborious, and time-consuming. The complexity of the snake-bone structure limits the minimum size of an endoscope, which may impair the application of the endoscope in a very small space or a special region. In some operations needing stable support, the snake-bone structure may be unlikely to provide sufficient rigidity, which may affect precision and effect of operation. The dexterity of the snake-bone structure will influence accuracy and comfort of endoscopic inspection. Therefore, more sophisticated fabrication-assemblage technologies are required to increase the dexterity, durability and safety of the snake-bone structure, which will lead to lengthy fabrication processes and high fabrication-assemblage cost.

Accordingly, the present invention proposes an endoscope, an embed-molded joint connector, and a manufacturing thereof to overcome the conventional problems.

### SUMMARY OF THE INVENTION

Considering the abovementioned problems, the primary objective of the present invention is to provide an endoscope featuring radial torsion durability and axial bending function, an embed-molded joint connector able to realize the aforementioned endoscope, and a manufacturing method thereof, whereby to enhance the efficiency of assemblage, improve stability of bending angles, increase durability of bending, and raise the ability of twist and turn to adapt itself to pathological anatomy.

In order to achieve the abovementioned objective, the present invention provides an embed-molded joint connector, which comprises a plurality of joint units, and a flexible wire. The joint units are hollow and arranged coaxially. Two adjacent joint units are separated by a distance, whereby to form a plurality of gaps therebetween. The flexible wire is embedded inside the joint units and passes through the joint units. A plurality of portions of the flexible wire is exposed in the gaps, forming bending fulcrums between the joint units.

In some embodiments of the present invention, each of the plurality of joint units respectively has at least one embedding channel where the flexible wire is embedded. Two ends of the at least one embedding channel respectively have protrusion members, which are extended outward with respect to the at least one embedding channel and connected with the flexible wire.

In some embodiments of the present invention, two adjacent joint units have a slit, which uses a corresponding bending fulcrum as the center. One side of two adjacent slits provides an outer expansion angle for the corresponding joint units. Another side of two adjacent slits provides an inner compression angle for the corresponding joint units. The width of the opening of the slit is greater than the width of the bending fulcrum.

In order to achieve the abovementioned objective, the present invention also provides a manufacturing method of an embed-molded joint connector, which comprises steps:
providing a joint mold, which includes a plurality of mold cavities, wherein the shape of the mold cavity is corresponding to the shape required by injection-molding of the joint unit mentioned above;
embedding the flexible wire inside the joint mold, wherein the flexible wire is inserted through each mold cavity;
injecting an injection material into the joint mold to encapsulate the flexible wire; and
opening the joint mold to obtain a plurality of joint units having the flexible wire so as to form an embed-molded joint connector.

In order to achieve the abovementioned objective, the present invention also provides an endoscope, which comprises the abovementioned embed-molded joint connector, a steering line, a camera connection module, and a component connection module. The plurality of joint units of the embed-molded joint connector has a steering line channel. The steering line is disposed inside the steering line channel and passes through the plurality of joint units. The steering line is parallel to the flexible wire. The camera connection module is disposed at one end of the embed-molded joint connector and connected with one end of the steering line. The component connection module is disposed at another end of the embed-molded joint connector, which is far away from the camera connection module, and connected with another end of the steering line.

According to the above statement, the endoscope, the embed-molded joint connector, and the manufacturing method of the present invention promote dexterity, durability, and safety of the overall apparatus. The present invention also increases the assembling efficiency, stabilizes the bending angle, improves the bending durability, and enhances the adaptability of operating the endoscope in twist and turn to perform pathological anatomy.

The objective, technologies, features and advantages of the present invention will become apparent from the following description in conjunction with the accompanying drawings wherein certain embodiments of the present invention are set forth by way of illustration and example.

### BRIEF DESCRIPTION OF THE DRAWINGS

The foregoing conceptions and their accompanying advantages of this invention will become more readily appreciated after being better understood by referring to the following detailed description, in conjunction with the accompanying drawings, wherein

FIG. 1 is a perspective view schematically showing an embed-molded joint connector according to a first embodiment of the present invention;

FIG. 2 is an enlarged view of Region R1 of FIG. 1;

FIG. 3 is a side view of Region R1 of FIG. 1;

FIG. 4 is a perspective view schematically showing an embed-molded joint connector according to a second embodiment of the present invention;

FIG. 5 is a sectional view of FIG. 4;

FIG. 6 is a side view of Region R2 of FIG. 4;

FIG. 7 is a diagram schematically the operation of the embed-molded joint connector of FIG. 4;

FIGS. 8-10 are local side views respectively schematically showing embed-molded joint connectors according to a third embodiment, a fourth embodiment, and a fifth embodiment of the present invention;

FIGS. 11-13 are sectional views respectively schematically showing embed-molded joint connectors according to other embodiments of the present invention;

FIG. 14 is a flowchart of a manufacturing method of an embed-molded joint connector according to one embodiment of the present invention;

FIG. 15 is a perspective view schematically showing an endoscope according to one embodiment of the present invention;

FIG. 16 is a diagram schematically the operation of an endoscope according to one embodiment of the present invention.

### DESCRIPTION OF THE PREFERRED EMBODIMENTS

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts of or all the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

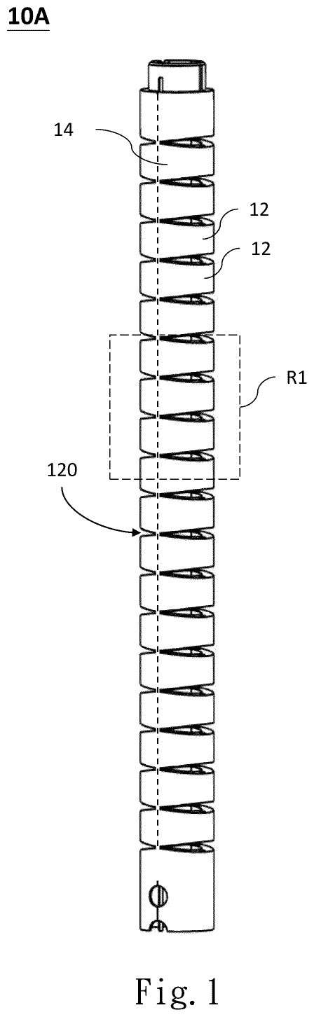

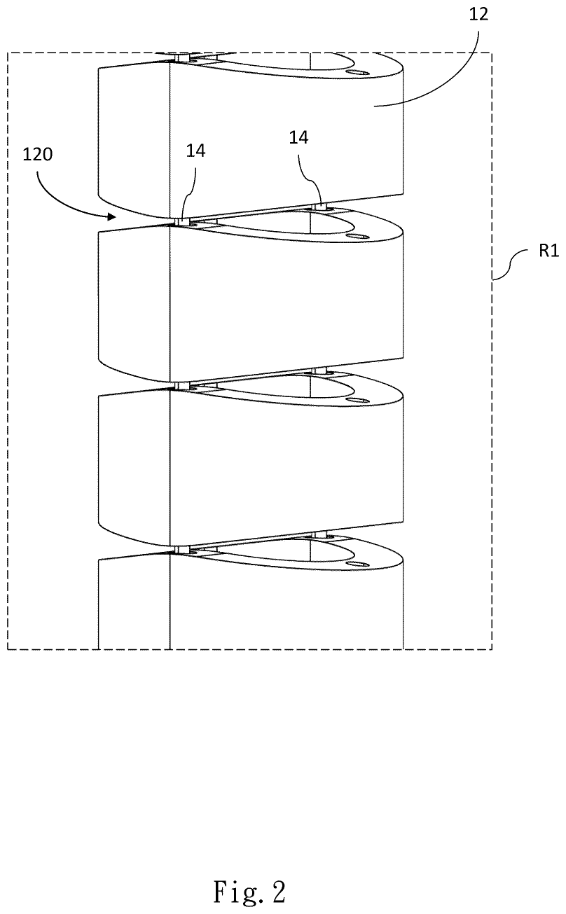

Refer to FIGS. 1-3. The embed-molded joint connector 10A according to Embodiment I of the present invention may be applied to an endoscope. The embed-molded joint connector 10A comprises a plurality of joint units 12 and flexible wires 14. The joint units 12 are hollow and arranged coaxially. Two adjacent joint units 20 are separated by a distance d, whereby to form a plurality of gaps 120 therebetween. The flexible wires 14 are embedded inside the joint units 20 and pass through the joint units 20. A plurality of portions of the flexible wires 14 is exposed in the gaps 120, respectively forming bending fulcrums P between the joint units 12.

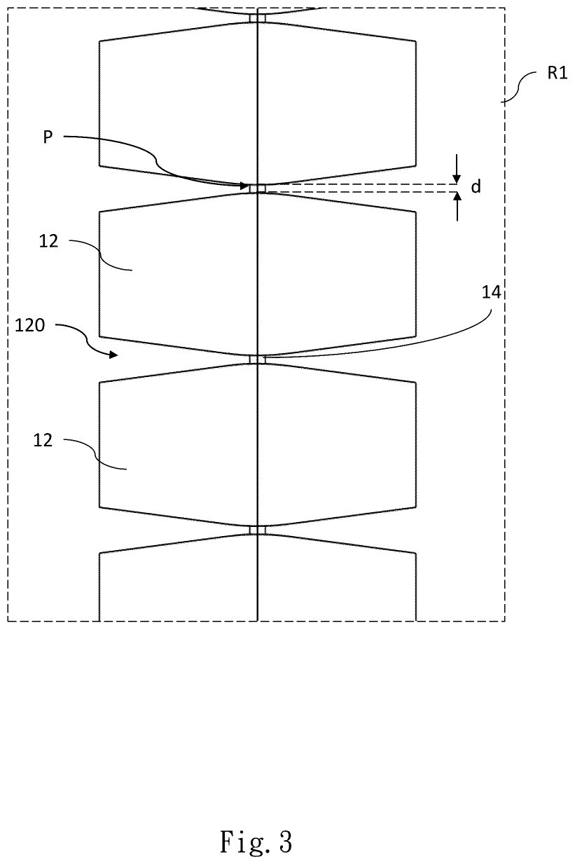

As shown in FIG. 3, two adjacent joint units 12 are neighboring to each other but not connected to each other. The small distance d (the gap 120) between two adjacent joint units 12 makes the flexible wires 14 exposed. The portions of the flexible wire 14, which are exposed in the gap 120, may function as the support structures (the fulcrums P) while the embed-molded joint connector 10A is bent. The flexible wire 14 may be but are not limited to be made of metallic material. It should be noted: the flexible wire 14 must have the following characteristics: (1) flexibility, (2) basic rigidity, and (3) tolerability to the temperature and other conditions required by the injection-embedding process, whereby to stably control the bending angle of the embed-molded joint connector 10A and prevent from the detachment of the joint units 12, and whereby to satisfy the dimensions required by miniaturized endoscopes and provide the flexibility and bendability for inspection. The rigidity of the flexible wire 14 may effectively limit the overall deformation. Thus, the endoscope may be twisted and turned to adapt itself to pathological anatomy.

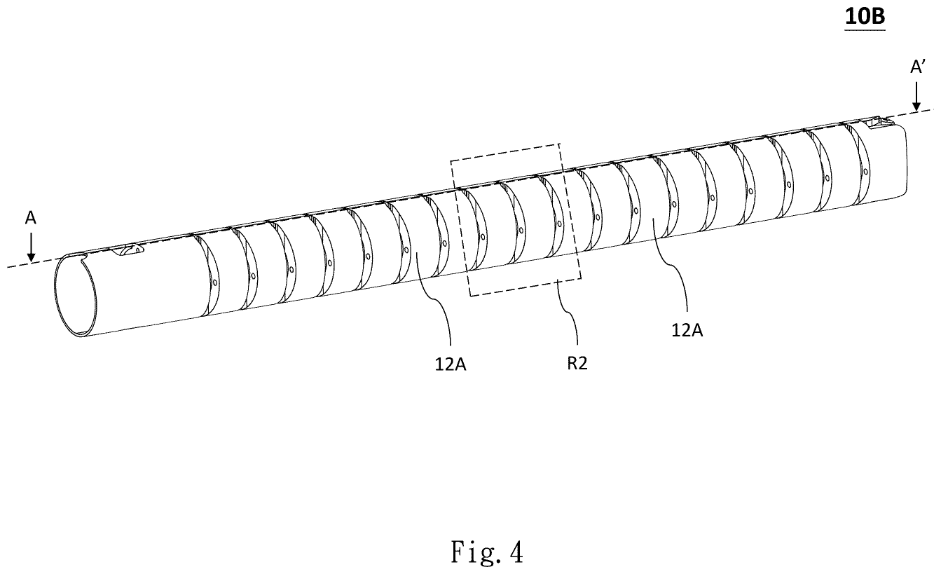

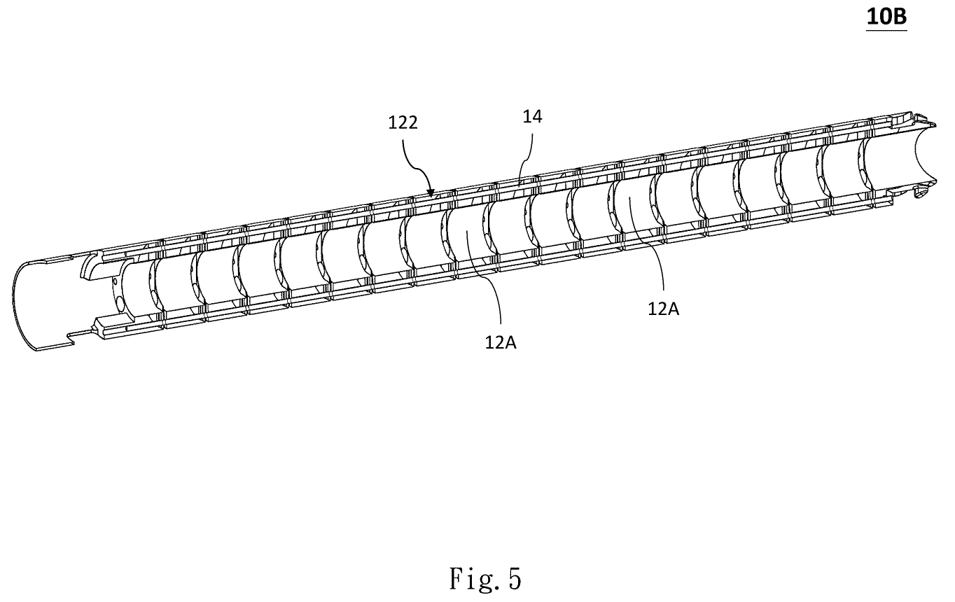

Below is introduced Embodiment II of the embed-molded joint connector. The elements that are the same as those mentioned above will not repeat herein. Refer to FIGS. 4-6. The plurality of joint units 12A of the embed-molded joint connector 10B has at least one embedding channel 122 where the flexible wires 14 are embedded. In each joint unit 12A, two ends of the at least one channel 122 respectively have protrusion members 124. The protrusion members 124 are extended outward with respect to the embedding channel 124 and connected with the flexible wire 14.

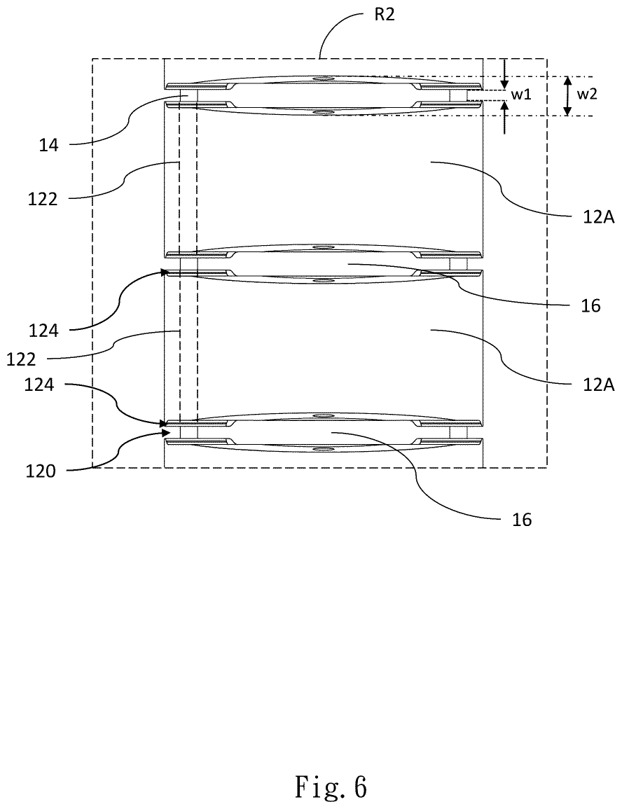

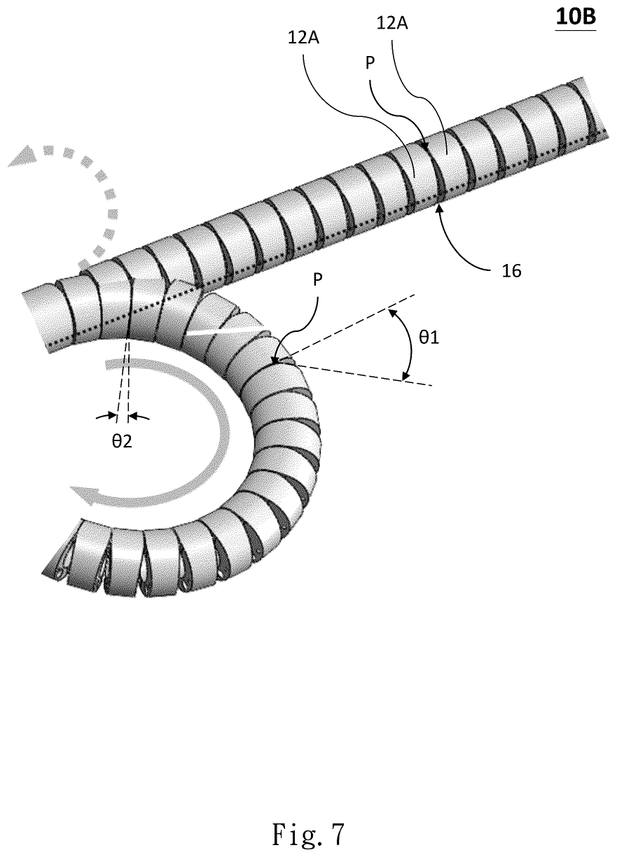

Refer to FIG. 6 and FIG. 7. The protrusion member 124 protrudes toward the gap 120. It is seen in the side view of FIG. 6: the gap 120 varies in shape corresponding to the protrusion structure to form a narrow slot having a special shape. In this embodiment, the narrow slot is called the slit 16. The width w2 of the opening of the slit 16 is greater than the width w1 of the bending fulcrum P. The slits 16 are respectively formed between the plurality of joint units 12A. Each of the slits 16 uses the corresponding bending fulcrum P as the center. One side of the slit 16 provides an outer expansion angle θ1 for the plurality of joint units 12A; another side of the slit 16 provides an inner compression angle θ2 for the plurality of joint units 12A. In some embodiments, the joint unit 12A is a plastic injection-molded thin pipe-like element, and the flexible wire 14 is embedded inside the injection-molded element. The flexible wire 14 may be a flexible cable, thread, metallic yarn, or non-metallic yarn. The flexible wire 14 passes through all the bendable joint units 12A, whereby to form a structure having radial torsion durability and axial bending function. In practical application, if an external force is applied to the joint units 12A, the rigidity of the flexible wire 12 may effectively constrain the overall deformation, whereas the flexibility of the flexible wire 14 enables the structure to be bended to an angle of required degrees. The embed-molded joint connector 10B may replace the conventional rotation-shaft press-fit structure. It is not necessary for the protrusion members 124 to press-fit to or press against other elements. The flexible wire 14, which is embedded inside and passed through all the joint units 12A, is sufficient to prevent the joint units 12A from axial detachment. The present invention may further increase the extent of bending of the overall embed-molded joint connector 10B and make it unlikely to loosen.

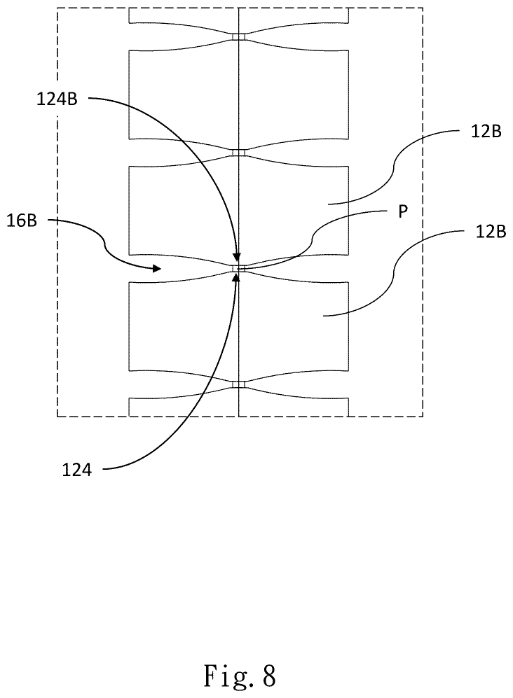

Below are introduced Embodiments III-V, wherein Embodiments III-V are different from Embodiment I in the protrusion member. Portions of the joint units are locally enlarged in FIGS. 8-10 to highlight the structural difference of the protrusion members. From the description of the embodiments and the locally-enlarged drawings, the persons having ordinary knowledge in the field should be able to appreciate the structural characteristics of the embed-molded joint connectors of those embodiments.

As shown in FIG. 8, the protrusion member 124B of the joint unit 12B has a smooth and slightly convex shape; the slit 18B between two adjacent joint units 12B has a trumpet-like shape or an expanded tube-like shape. The slit 16B is narrower in the region near the bending fulcrum P and growing wider while it is being extended toward the opening thereof, seeming to have a shape of a trumpet or a funnel.

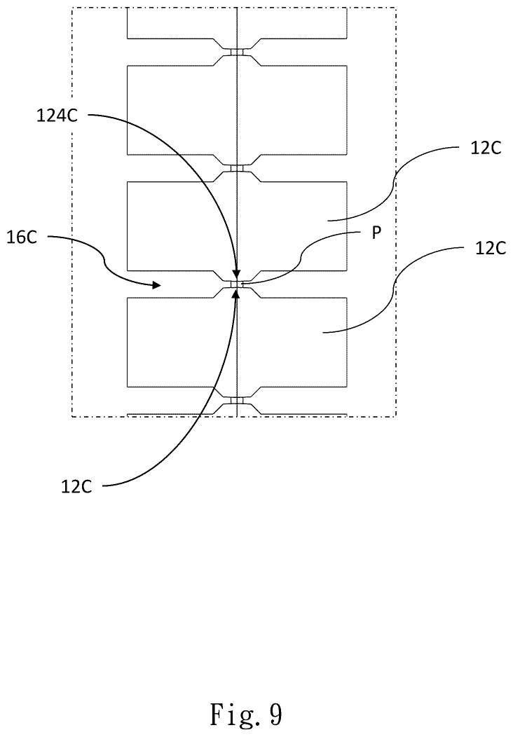

As shown in FIG. 9, the protrusion member 124C of the joint unit 12C has a trapezoid-like shape; the slit 18C between two adjacent joint units 12C has a rectangular shape. The slit 16C is narrower in the region near the bending fulcrum P and growing wider while it is being extended toward the opening thereof.

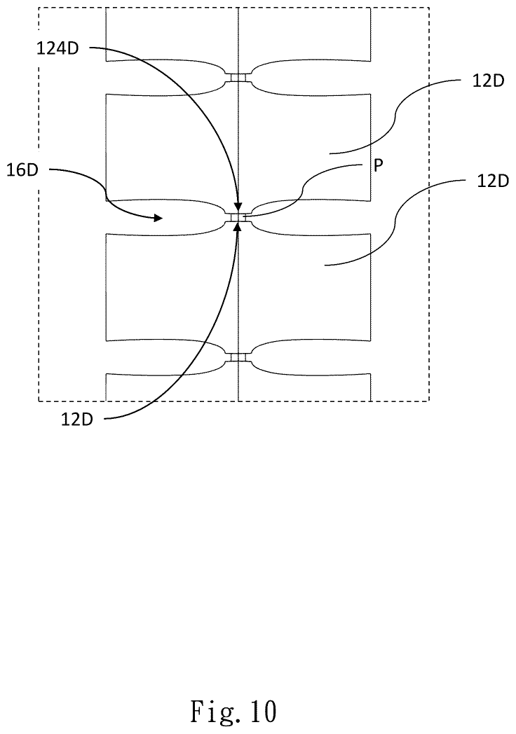

As shown in FIG. 10, the protrusion member 124D of the joint unit 12D has a trapezoid-like shape; the slit 18D between two adjacent joint units 12D has a smooth arc shape. The slit 16D is narrower in the region near the bending fulcrum P and growing wider while it is being extended toward the opening thereof. The upper and lower sides of the slit 16D present smooth arc shapes, whereas the overall appearance of the slit 16D seems to be two parallel curves extended outward.

It is easily understood: in order to achieve the required bending angle and bending curvature, the shape and structure of the protrusion member must match the cross-section and size of the flexible wire. Thereby, less waste is generated in the injection molding process, and the fabrication cost is reduced. Thus, mass production is favored.

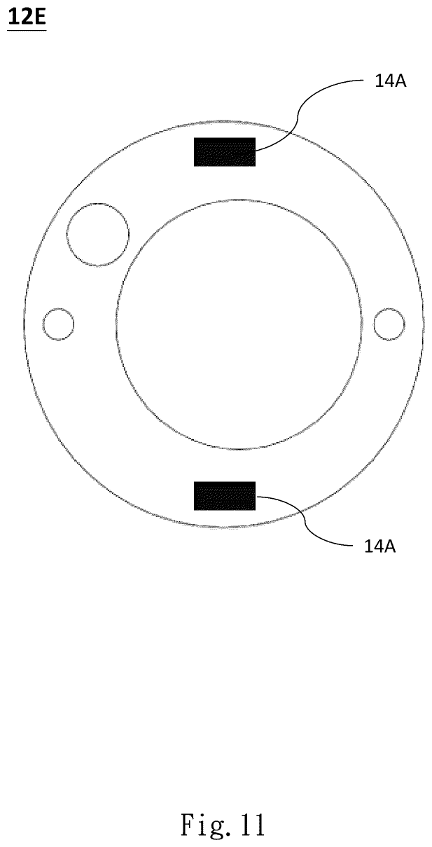

Below are introduced several embodiments of the flexible wire. Refer to FIGS. 11-13, which show the cross sections of the joint unit of the embed-molded joint connector to clearly present the characteristics of the flexible wire. It is preferred by the present invention: two flexible wires are used in the embed-molded joint connector. Two flexible wires are disposed oppositely to favor the bending durability and twist durability of the embed-molded joint connector in practical application and improve the controllability in bending the embed-molded joint connector. However, one or more flexible wires may be adopted in practical application according to requirement.

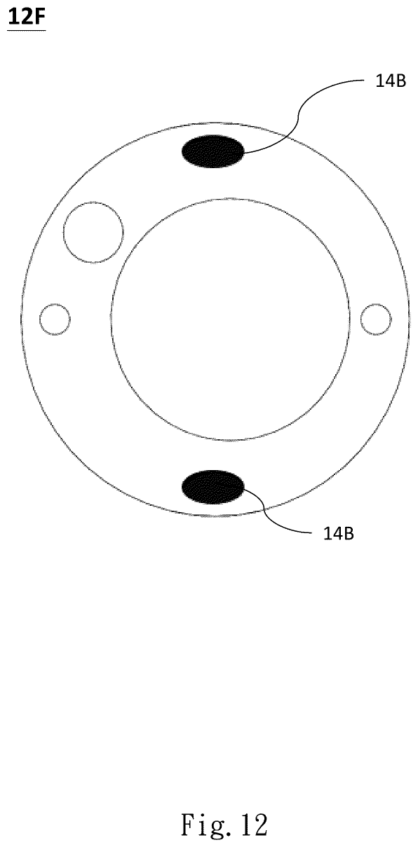

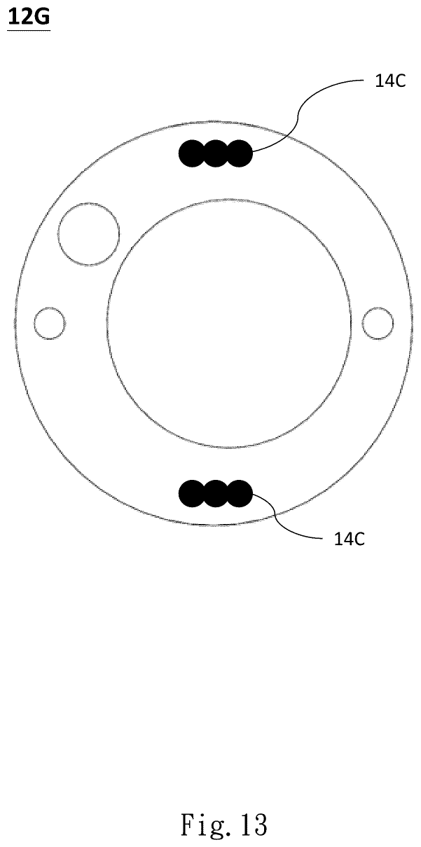

As shown in FIG. 11, the cross section of the flexible wires 14A embedded in the joint unit 12E has a rectangular shape. As shown in FIG. 12, the cross section of the flexible wires 14B embedded in the joint unit 12F has an elliptical shape. As shown in FIG. 13, the cross section of the flexible wires 14C embedded in the joint unit 12G has a shape of several circles joined together. If two flexible wires shown in FIGS. 11-13 are used, the embed-molded joint connector would have higher twist durability and would be able to tolerate higher stress and strain of torsion. Thereby, the embed-molded joint connector is less likely to be damaged by over twist. The conventional snake-bone structure is unlikely to operate unless the rotation axes are contacted or connected to each other. The present invention overcomes the conventional problem caused by using rotation axes. Therefore, the present invention is exempted from the problem of structural disconnection.

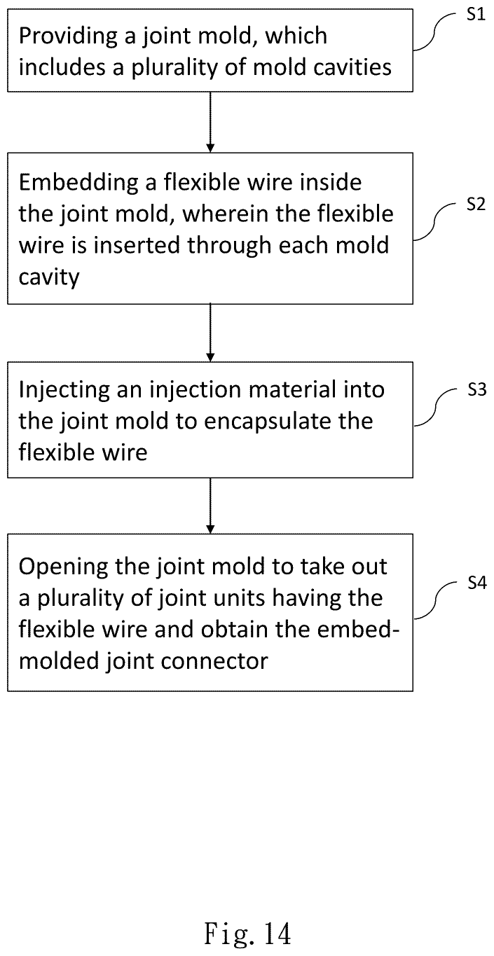

The manufacturing method of the embed-molded joint connector has been introduced briefly in the description of the embed-molded joint connector of the present invention. However, the flowchart shown in FIG. 14 is used to further demonstrate the manufacturing method more clearly. As shown in FIG. 14, the manufacturing method of the embed-molded joint connector comprises Steps S1-S4.

In Step S1, provide a joint mold, which includes a plurality of mold cavities, wherein the shape of the mold cavity is corresponding to the shape required by injection-molding of the joint unit mentioned in abovementioned embodiments.

In Step S2, embed the flexible wire inside the joint mold, wherein the flexible wire is inserted through each mold cavity.

In Step S3, inject an injection material into the joint mold to encapsulate the flexible wire.

In Step S4, open the joint mold to obtain a plurality of joint units having the flexible wire so as to form an embed-molded joint connector.

In the present invention, the manufacturing method of the embed-molded joint connector uses a single-stage-production injection-molding technology to fabricate a joint connector containing a plurality of joint units and a flexible wire embedded thereinside. Therefore, the manufacturing method of the present invention can simplify the assembling process, increase the assembling efficiency, decrease the accumulated error, and overcome the conventional problem that requires precision fabrication and assembling technologies. Therefore, the present invention is exempted from complicated fabricating and assembling steps, able to reduce the complexity of fabrication, promote the yield of products, and lower the cost of material and manpower.

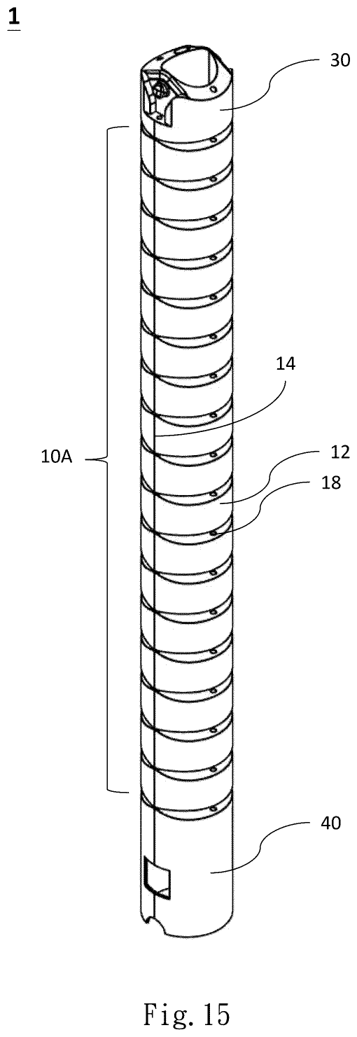

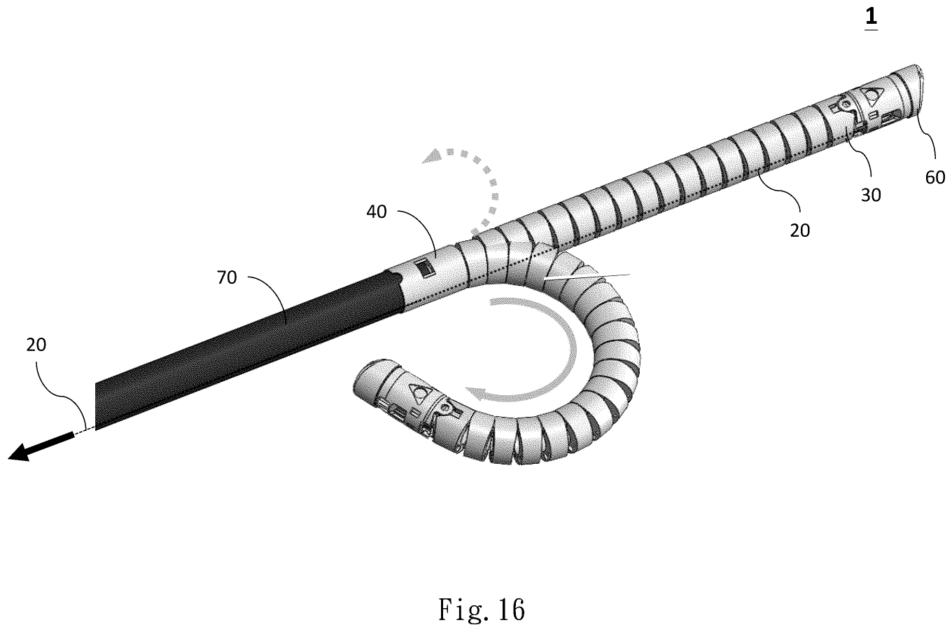

Refer to FIG. 15 and FIG. 16. The endoscope 1 comprises the abovementioned embed-molded joint connector 10A, a steering line 20, a camera connection module 30, and a component connection module 40. The embed-molded joint connector 10A may be replaced by any one of the embed-molded joint connectors of the other embodiments described above. Each of the joint unit 12 of the embed-molded joint connector 10A has a steering line channel 18. The steering line 20 is disposed inside the steering line channel 18 and passes through the plurality of joint units 12. The steering line 20 may be parallel to the flexible wire 14. The camera connection module 30 is disposed at one end of the embed-molded joint connector 10A and connected with one end of the steering line 20. The component connection module 40 is disposed at another end of the embed-molded joint connector 10A, which is far away from the camera connection module 30. The component connection module 40 is connected with another end of the steering line 20. The front end of the camera connection module 30 is connected with an optical image sensing module 60. The terminal end of the component connection module 40 is connected with other control components 70, including signal cables, an accommodation space of the steering line 20, and a passageway of the steering line 20.

According to the abovementioned structures, pulling the steering line 20 effectively makes the embed-molded joint connector 10A rotate with respect to the bending fulcrum P between the joint units 12, reduces the spacing on one side of the slits, expands one side of the joint units 12 to an outer expansion angle, compresses the other side of the joint units 12 to an inner compression angle, and finally turns the direction of the optical image sensing module 60, which is connected with the front end of the camera connection module 30. The design of the present invention also enhances the reliability and tightness of the connection between the joint units 12.

In conclusion, the present invention is able to effectively reduce the size of the embed-molded joint connector and miniaturize endoscopes furthermore. While applied to inspecting special areas, very narrow regions, or high-risk positions, the present invention provides higher supportability, operability, durability, and safety. Further, the present invention increases assembling efficiency, stabilizes bending angles, improves bending durability, and raises the adaptability to pathological anatomy where the operator needs to operate the endoscope in twist and turn.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the appended claims.

1. An embed-molded joint connector comprising
a plurality of joint units, hollow and arranged coaxially, wherein each two adjacent ones of the joint units are separated by a distance to form a plurality of gaps therebetween; and
a flexible wire, embedded inside the plurality of joint units, and passing through the plurality of joint units, wherein a plurality of portions of the flexible wire is exposed in the plurality of gaps to form a bending fulcrum between each two adjacent ones of the joint units.

2. The embed-molded joint connector according to claim 1, wherein the plurality of joint units respectively has at least one embedding channel where the flexible wire is embedded.

3. The embed-molded joint connector according to claim 2, wherein two ends of the at least one embedding channel respectively have protrusion members, which are extended outward with respect to the at least one embedding channel and connected with the flexible wire.

4. The embed-molded joint connector according to claim 1, wherein slits are respectively formed between the plurality of joint units; each of the slits uses the corresponding bending fulcrum as a center; one side of the slit provides an outer expansion angle for the plurality of joint units; another side of the slit provides an inner compression angle for the plurality of joint units.

5. The embed-molded joint connector according to claim 4, wherein a width of an opening of the slit is greater than a width of the bending fulcrum.

6. The embed-molded joint connector according to claim 1, wherein one or more flexible wires are used.

7. The embed-molded joint connector according to claim 1, wherein a cross section of the flexible wires has a rectangular shape, an elliptical shape, or a shape of several circles joined together.

8. A manufacturing method of an embed-molded joint connector, comprises steps:
providing a joint mold, which includes a plurality of mold cavities, wherein a shape of the mold cavity is corresponding to a shape required by injection-molding of the embed-molded joint unit of claim 1;
embedding a flexible wire inside the joint mold, wherein the flexible wire is inserted through each mold cavity;
injecting an injection material into the joint mold to encapsulate the flexible wire; and
opening the joint mold to take out a plurality of joint units having the flexible wire and obtain the embed-molded joint connector.

9. An endoscope comprising:
the embed-molded joint connector of claim 1, wherein the plurality of joint units has a steering line channel;
a steering line, disposed inside the steering line channel, and passing through the plurality of joint units, wherein the steering line is parallel to the flexible wire;
a camera connection module, disposed at one end of the embed-molded joint connector and connected with one end of the steering line; and
a component connection module, disposed at another end of the embed-molded joint connector, which is far away from the camera connection module, and connected with another end of the steering line.
